(19) United States
(12) Patent Application Publication
(10) Pub. No.: US 2016/0357965 A1
(43) Pub. Date: Dec. 8, 2016

(54) AUTOMATIC CLUSTERING OF MALWARE VARIANTS BASED ON STRUCTURED CONTROL FLOW

(71) Applicant: UT Battelle, LLC, Oak Ridge, TN (US)

(72) Inventors: Stacy J. Prowell, Oak Ridge, TN (US); Kirk D. Sayre, Oak Ridge, TN (US); Rima L. Awad, Oak Ridge, TN (US)

(21) Appl. No.: 15/172,884

(22) Filed: Jun. 3, 2016

Related U.S. Application Data
(60) Provisional application No. 62/170,758, filed on Jun. 4, 2015.

(51) Int. Cl. G06F 21/56; G06F 17/30; G06F 21/62

(52) U.S. Cl. CPC G06F 21/566; G06F 21/6218; G06F 17/30961; G06F 2221/033

(57) ABSTRACT

A computer network computer server device accesses software from a file. The device builds a structured flow control that maps the software's execution paths. The structured flow control is evaluated using multiple distance measures to determine if a portion of the software is malicious.

### PRIORITY CLAIM

This application claims priority to U.S. Provisional Patent Application No. 62/170,758, filed Jun. 4, 2015, titled “Automatic Clustering of Malware Variants Based on Structured Control Flow,” which is herein incorporated by reference.

### STATEMENT REGARDING FEDERALLY SPONSORED RESEARCH AND DEVELOPMENT

This invention was made with United States government support under Contract No. DE-ACO5-000R22725 awarded by the United States Department of Energy. The United States government has certain rights in the invention.

### BACKGROUND

Technical Field

This disclosure relates to malware and more specifically to identifying malware variants by processing structured flow control.

Related Art

Malicious software or malware has become a serious threat to computer systems and the Internet. The creation of new malware instances has become more common with the emergence of automatic malware creation toolkits. Malware writers create a significant number of complex and obfuscated malware variants that mutate and elude antivirus scanners by simply modifying existing malware instances. Typically, antivirus companies processes new malware instances manually to determine their maliciousness and identify their signatures. But with the overwhelming number of new malware instances that are now created automatically, manual analysis is ineffective and has been slow to respond to new emerging threats.

Thus, the fully automated malware clustering system (and process) disclosed below addresses this threat. It eliminates the need for manual malware inspection and speeds up malware classification by clustering variants of malware instances. By identifying the invariant features of malware families in this fully automated turnkey system (and process) the classification of malware variants occurs quickly and is more efficient.

### DESCRIPTION OF THE DRAWINGS

The patent or application file contains at least one drawing executed in color. The Office upon request and payment of the necessary fee will provide copies of this patent or publication with color drawing(s).

FIG. 1 is a screenshot of assembly instructions with obfuscated malware.

FIG. 2 is the control flow of a sample of obfuscated malware.

FIG. 3 shows assembly instructions of the structured control flow.

FIG. 4 is a structured control flow representation of FIG. 3.

FIG. 5 shows a sample output cluster.

FIG. 6 shows the shared functions between malware instances.

FIG. 7 is a clustering with a threshold value of a smallest string divided by five with fifty percent or more shared local functions.

FIG. 8 shows individual clusters that were randomly selected to verify the results of FIG. 7.

FIG. 9 shows clustering with threshold of the smallest string divided by five with seventy percent or more shared local functions.

FIG. 10 shows sample clusters of the results generated in FIG. 9.

FIG. 11 is clustering with threshold of the smallest string divided by five with ninety-five percent or more shared local functions.

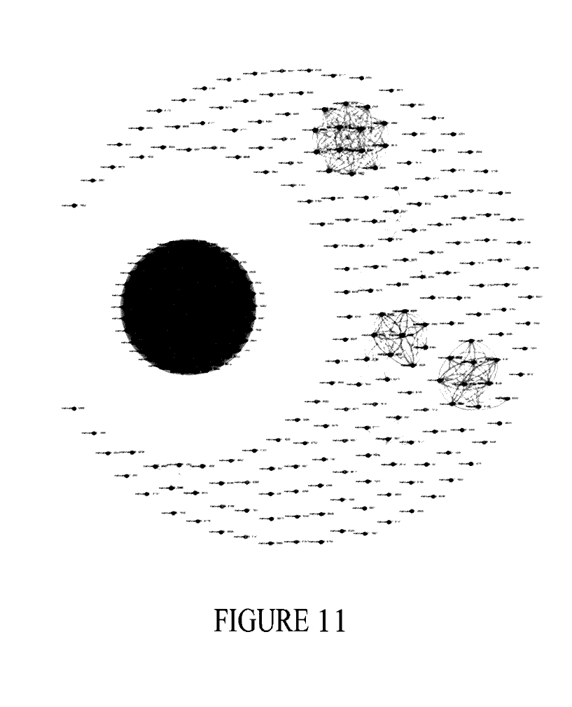

FIG. 12 shows sample clusters of the results generated in FIG. 11.

FIG. 13 is a clustering with a threshold value of the smallest string divided by twenty with fifty percent or more shared local functions.

FIG. 14 shows individual clusters that were randomly selected to verify the results of FIG. 13.

FIG. 15 shows clustering with threshold of the smallest string divided by twenty with seventy percent or more shared local functions.

FIG. 16 shows sample clusters of the results generated in FIG. 15.

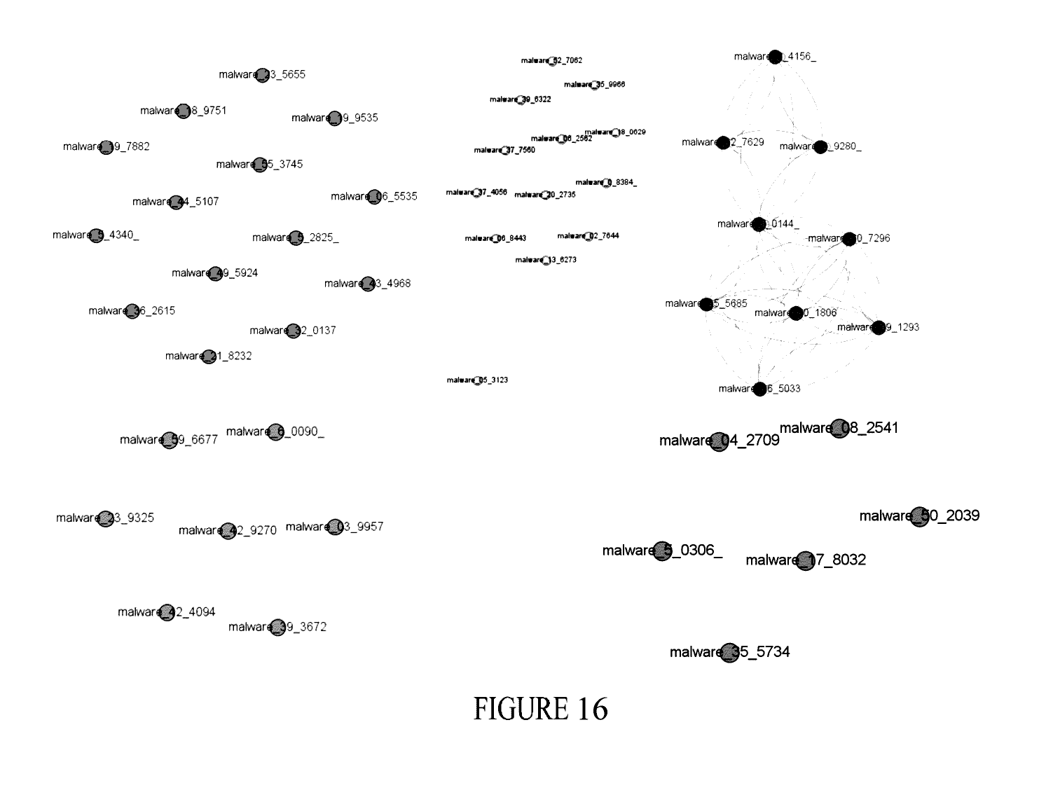

FIG. 17 shows clustering with threshold of the smallest string divided by twenty with ninety five percent or more shared local functions.

FIG. 18 shows sample clusters of the results generated in FIG. 17.

FIG. 19 shows clustering with threshold of the smallest string divided by fifty with fifty percent or more shared local functions.

FIG. 20 shows sample clusters of the results generated in FIG. 19.

FIG. 21 shows clustering with threshold of the smallest string divided by fifty with seventy percent or more shared local functions.

FIG. 22 shows sample clusters of the results generated in FIG. 21.

FIG. 23 shows clustering with threshold of the smallest string divided by fifty with ninety five percent or more shared local functions.

FIG. 24 shows sample clusters of the results generated in FIG. 23.

FIG. 25 is a block diagram of a system that identifies malware.

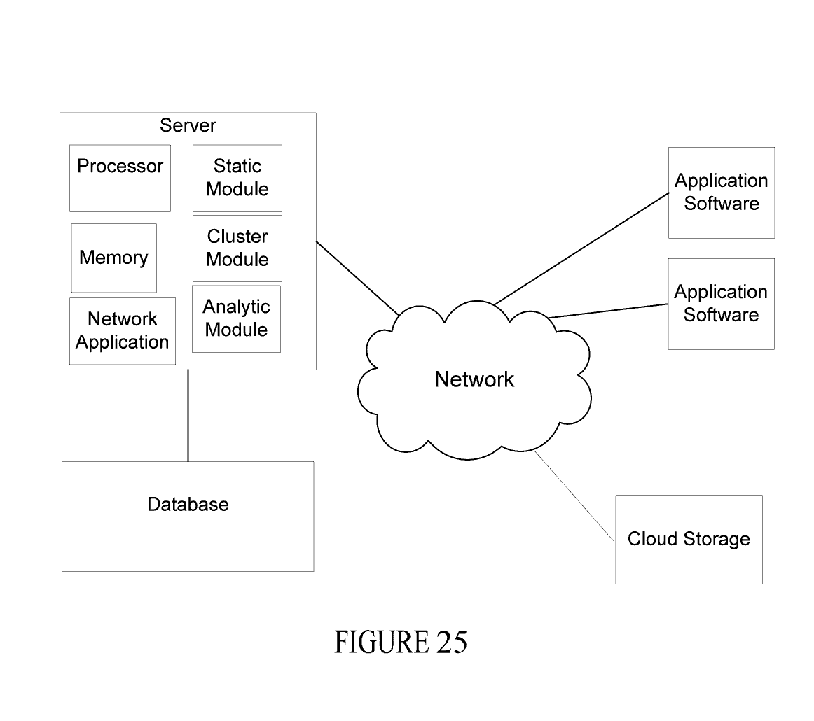

Appendix 1-8 system (and process) clustering code.

### DETAILED DESCRIPTION OF THE PREFERRED EMBODIMENTS

The disclosed systems (and processes) generate a computed structured control flow (SCF) of a targeted program to identify malware. A static analysis of the compiled targeted software, which may be generated by a function extraction (FX) system, such as Oak Ridge National Laboratory's (ORNL) “Hyperion” system, generates the SCF of the targeted software or program. The computed SCF is a graphical, a string, or a tree representation of all the flow paths that can be traversed through the targeted program during the program's execution. Some computed structures consist of if-then-else, while-do, case and sequence programming constructs, for example. The systems (and processes) reduce the computed structure that are represented as symbolic and/or alphanumeric strings, trees, or graphs in which multiple sequence nodes are reduced to a single node with the exception of external procedure calls. The external procedure calls that are also known as external calls are preserved, and both branching and looping constructs are captured without the details of the external procedure calls. This results in expressions that capture the programming structure, but not its content. The symbolic and alphanumeric strings are then compared using a designated metric such as string edit distance or graph edit distance. The computed values are processed with a metric-based clustering process or quality threshold clustering (QTC) to discover similar programs and/or program fragments including malware variants. Malware clustering is the process of grouping malware variants that share invariant features.

In one implementation, an FX tool generates the SCF, an invariant feature shared by malware variants of the same family. FX, like a static module, is an automatic static analysis and function extraction tool that assists in the analysis of software. The FX tool extracts a structured form of the control flow of malware instances while removing dead code blocks (non-functional code) and eliminating “spaghetti-logic” (incoherent structure in a program that incorporates frequent execution jumps). ORNL maintains the FX tool “Hyperion.” Unlike dynamic analysis, the disclosed static analysis allows for the analysis of the full malware behavior and eliminates the possibility of an emulated environment being detected by malware. The FX tool analyzes the full-targeted program and computes the end-to-end behavior of the targeted program. An SCF is generated by the FX tool by a process that: (1) extracts the digital code (2) disassembles the malware and non-malware executable: (3) scans its instructions; (4) generates the unstructured malware control flow; and (5) structures the unstructured control flow generated in (4). The resulting SCF of the targeted program maps the targeted program's different execution paths through the program with the program's arbitrary jumps eliminated.

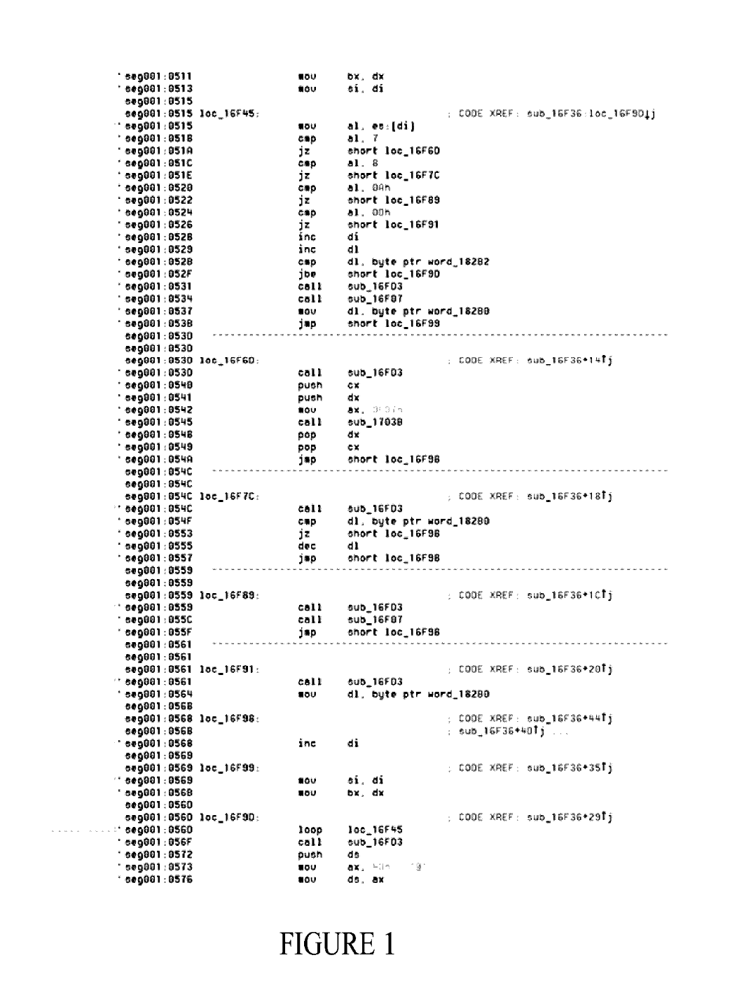

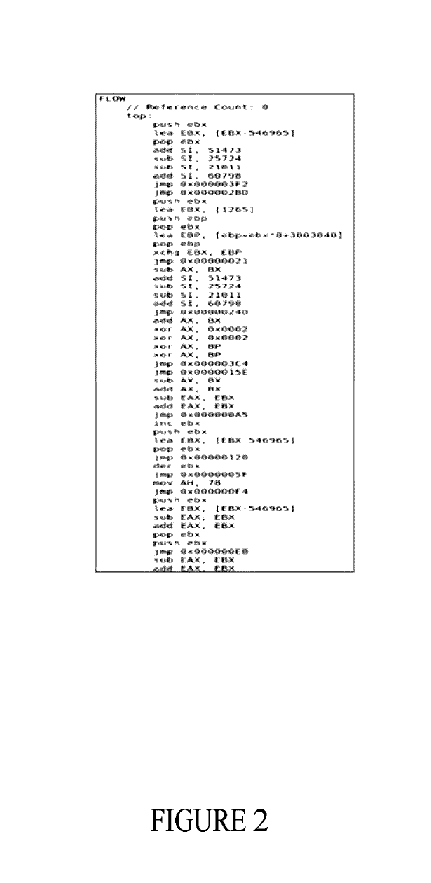

The assembly instructions generated by the FX tool are augmented with corresponding functional semantics that account for the effect that each instruction has on the state of the hardware executing the targeted program's instructions. The targeted program's true control flow is generated and transformed into the SCF by applying a structure theorem to it. FIGS. 1 and 2 shows the exemplary disassembly of malware that has been obfuscated by the insertion of arbitrary jumps and the SCF after removing the obfuscation.

Due to the large size of the structured flow-controls generated by the FX tool, the systems (and processes) transform the SCFs into a pattern of characters used to represent the disassembly referred to as regular expression or regex. Regex is a string notation that consists of pattern of characters used to represent an abstract form of disassembled targeted-program.

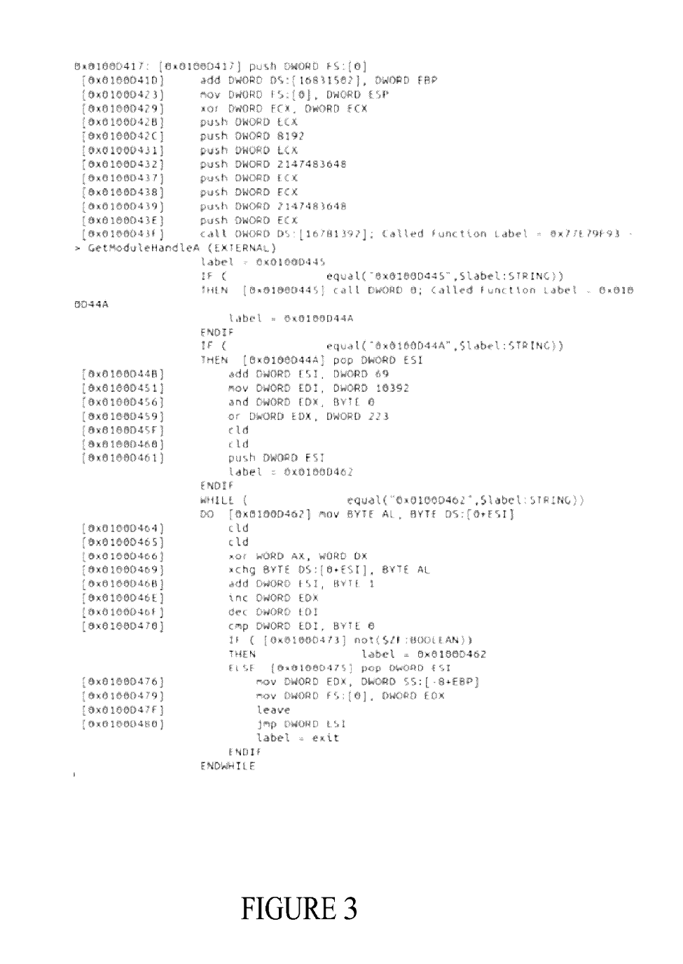

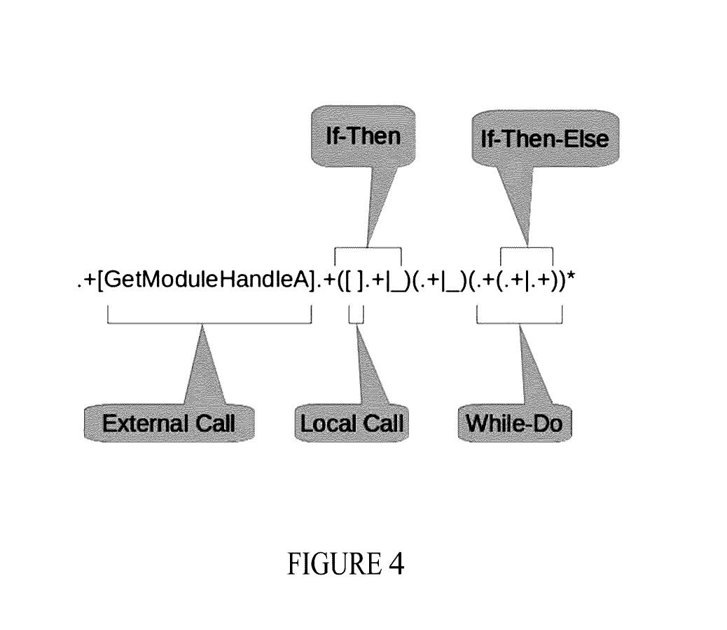

The regex control flow strings abstract the full SCF for each local function in the malware program. The regex control flow strings keep information about if-then-else, loops, and call functions, but abstract away information about the specific assembly instructions used by the targeted-program. FIGS. 3 and 4 show exemplary SCF of a local function in a malware instance before and after being abstracted by the systems (and processes) using regex.

In FIG. 4, the assembly instructions of the malware program have been abstracted in the form of (.+).The (.) sign of the SCF regex represents a single non-branching assembly instruction of the malware program. The (+) sign in the (.+) notation establishes that there are one or more non-branching assembly instructions in a sequence. The regex of the SCF also includes information about the external calls of the function, which determines the malicious behavior of what may be infecting the targeted program. External calls are represented by brackets with the name of the external call enclosed within the brackets. In addition to the abstracted assembly instructions and external calls, the regex strings include information about the control structures of the targeted program. For example, FIG. 4 contains three if statements which have been abstracted in the form of parentheses with the abstraction of the assembly instructions inside the parentheses and the pipeline (|) to indicate the presence of then and else conditions. FIG. 4 also shows an abstraction of a while loop generated in the form of parentheses with the abstraction of the assembly instructions and an if statement inside the loop, and a star at the end to indicate that the loop may be executed zero or more times.

To determine the similarity between the SCF regex strings the systems (and processes) generate a metric. A metric value expresses the similarity of the SCF regex strings. A string edit distance metric such as a Levenshtein edit distance or a Sift3 string edit distance, for example, measures the similarity between the SCF regex strings. The similarity between two or more strings is expressed as a numerical value in the interval from zero (no similarity between the strings) to one (the strings are the same).

Based on a calculated metric, the systems (and processes) via a clustering module calculate a threshold value for the QTC algorithm, which groups similar, SCF regex strings (or alternatively tree structures) into clusters. The systems (and processes) determine the threshold value by calculating the edit distance between malware SCF regex strings. Some implementations calculate a threshold value by dividing the smallest length of the SCF regex strings by a factor (n) of five (n*5), with a divisor of 20 being one of the most effective in some applications. Empirical evaluations establish that the smallest length of the SCF regex strings divided by an overestimated value is also an effective threshold value for the QTC algorithm.

In some systems (and processes) the threshold value processed by the QTC algorithm defines the maximum edit distance value between the SCF regex string at the center of any cluster and the rest of SCF strings in that same cluster. Therefore, when the systems (and processes) use an overestimated threshold value, the systems (and processes) allow for a higher edit distance value between the SCF strings and cluster SCF strings with less similarity. While using a tighter threshold value means the systems (and processes) allow for lower edit distance value between the SCF regex strings, the tighter threshold value increases the clustering of highly similar SCF regex strings.

A clustering may be implemented with a modified QTC algorithm as follows. First, the process initializes the threshold distance that is allowed between the data points of the clusters. The algorithm then builds a candidate cluster for each data point by determining which data point has the greatest similarity with the chosen point. Next, the closest points are added to the cluster without surpassing the diameter threshold value. Then a candidate cluster with the most points is stored in memory as a cluster and its points are excluded from further processing. The process then repeats itself with the reduced data set (the original dataset without the excluded points) until no more clusters are formed. Data points that are not related to other data points are designated as outliers of the clusters and are not grouped.

Some systems (and processes) are based on the automatic static analysis generated by FX tool. The systems (and processes) target the SCF of the malware instances because that SCF reflects the actual functionality of a malware variant, and can be used as a unique feature that identifies malware families.

The systems (and processes) generate both the SCF of a program and the computed behavior. The program's computed behavior is a unique feature that identifies a malware family and can also be used in the clustering process. However, generating the computed behavior of a targeted-program is a complex and time consuming process in comparison to processing the SCF.

The systems (and processes) render various output of the SCF of the analyzed malware instance, such as graphs, human readable assembly instructions, and regex strings. To facilitate the comparison of the SCF of different malware instances, some systems (and processes) output the SCF in in a structure of successive branching and subdivisions known as a tree structure or regex strings. A tree structure is defined (locally) as a collection of nodes that initiate at a root node, where each node is a data structure consisting of a value, together with a list of references to nodes (the “children”), with the constraints that no reference is duplicated, and the structure contains no cycles. Regex is a sequence of characters that define a search pattern, mainly for use in pattern matching with strings, or string matching. Regex strings abstract out all of the individual assembly instructions, resulting in a much shorter string that is faster to cluster.

To test the systems (and processes) SCF regex strings for individual functions of 303 Windows PE malware instances were merged into a text file. The systems (and processes) calculated the edit distance between all of the generated strings and applied the QTC clustering algorithm. Regex strings of the SCF were classified based on their sizes. SCF regex strings passed to the clustering function by the fully automated systems (and processes) applied clustering application on groups that consisted of fifty strings. The system (and processes) broke down the initial regex strings into group sizes decreasing the time associated with the processing of the edit distance and the clustering.

To estimate the threshold value used by the QTC algorithm, the systems (and processes) calculated the smallest regex string length of each group and divided it by a programmable value. After estimating the suitable threshold value, the calculated edit distance between regex strings in the groups were processed by the QTC algorithm to determine the similarity between the SCF regex strings of local functions of the malware instances. Local functions that share very similar SCF regex strings are clustered together by the systems (and processes).

After obtaining the clusters of malware local functions that had very similar SCFs, the systems (and processes) mapped each local function back to the malware instance containing the local function. The result of this mapping show clusters of malware instances that share at least one local function based on the SCF of the local functions.

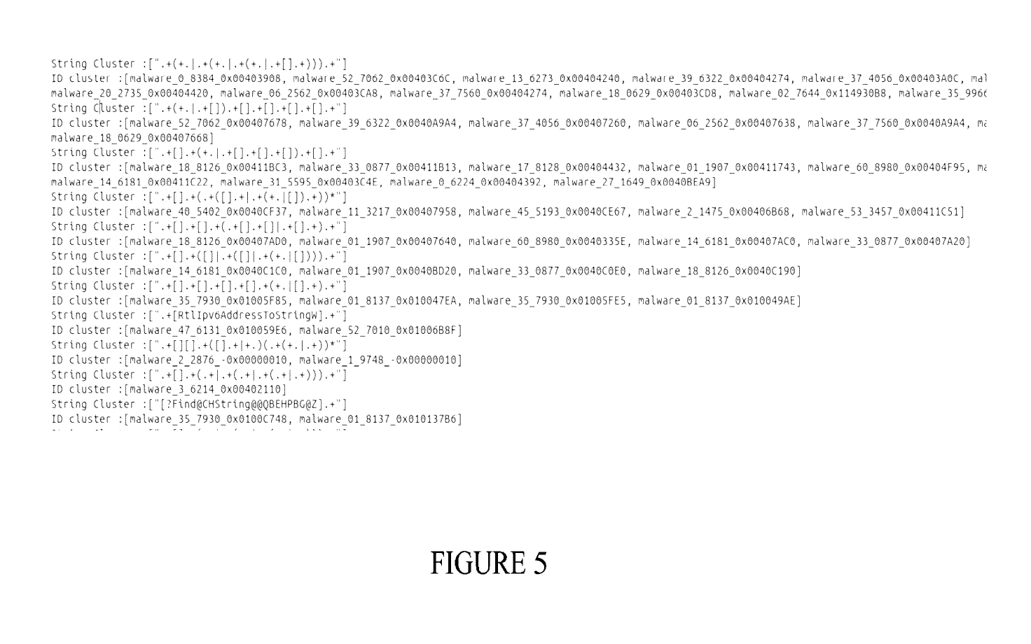

FIG. 5 shows a portion of the output of the systems (and processes). In FIG. 5, the content of the string clusters are the SCF regex strings that are similar, while the content of the ID clusters is the address of the local functions of the SCF regex strings that were clustered together. In FIG. 5, the malware instances sharing higher number of functions are variants of the same family.

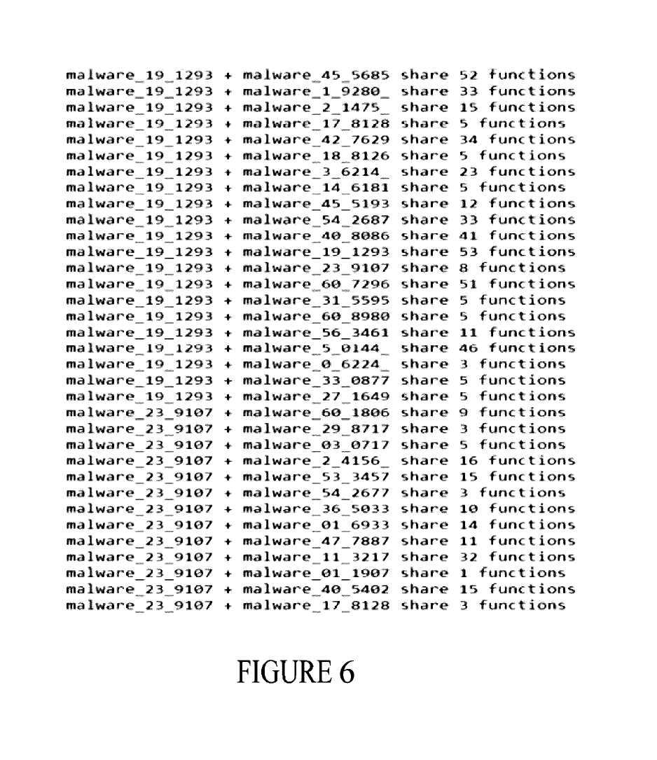

FIG. 6 shows the partial output of the shared functions between malware pairs. In FIG. 6, each malware instance of our target-program sample is compared to the rest of the malware instances. The number of the local functions of two-malware instances that were clustered together was processed. The output shows that malware_23_9107 and malware_19_1293 are very similar because they share a similar SCF regex strings for fifty-three local functions.

To identify malware instances that should be clustered together and identified as one malware family, the systems (and processes) calculate the percentage of shared local functions between each pair of malware instance. The systems (and processes) then execute clustering by processing different percentage values of the shared function. The systems (and processes) added edges of the output graph that represent the relationship between the malware instances, based on the used percentage. In other words, an edge between a pair of malware instances was added when the percentage of shared functions exceeded about fifty percent, seventy percent and ninety-five percent.

To graphically visualize the relationship between the malware instances the systems (and processes) accessed a a graph visualization package such as a JGraphT Java library to generate a Graph Modeling Language (GML) file that presents the relationships between the malware instances in the form of nodes and edges of a directed graph. To display the content of the generated GML file, the systems (and processes) executed Gephie, an open source tool for visualizing and analyzing graphs written in Java using the NetBeans platform to visualize the clustering results. The result of this analysis was a directed graph that consisted of 303 Windows PE malware, presenting the malware instances, and a number of edges that change when different metrics were processed. The edges connect the nodes and present the strength of the relationship between them. Further, the systems (and processes) calculate the modularity of the graph, which describes how the graph is compartmentalized into sub-graphs based on the strength between the clusters nodes. The modularity was then used to partition the graph into sub-graphs. The systems (and processes) rendered a graph that groups malware instances with a high similarity into clusters and presents them using unique colors.

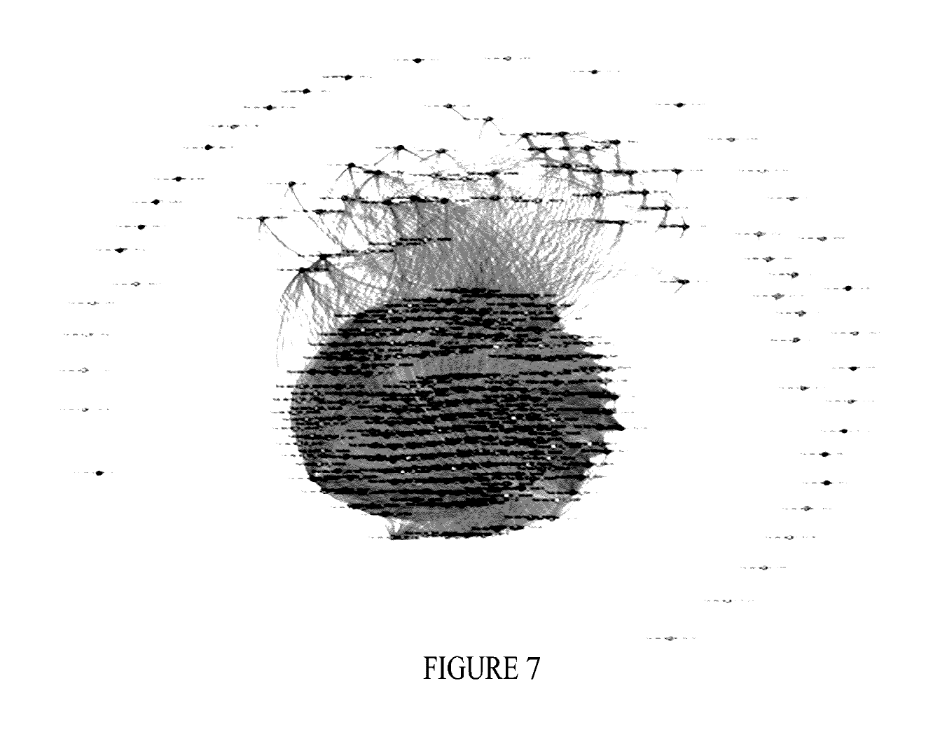

In exemplary use, the systems (and processes) apply the smallest length of regex string in each group, and added edges to the full clustering application when two malware instances share fifty percent, seventy percent and ninety-five percent of the total local functions. FIG. 7 shows a graphical presentation of the systems (and processes) initial clustering results. Nodes of the graph are representations of the 303 Windows PE malware instances used in this sample, and the edges of the graph represent the existence of a fifty percent shared local functions between the connected malware instances. The weight of the edges represents the number of shared functions between the malware instances. Nodes of the graph show functions that are strongly connected, that is, connected with edges with high weights, indicating a high similarity between the two malware instances SCFs. Nodes that share the same color are elements of the same cluster of malware instances. Nodes that are not connected to other nodes are identified with unique colors. These malware instances do not belong to any of the malware families represented by the clusters. The graph shown in FIG. 7 consisted of 303 nodes, 30710 edges, and 43 clusters.

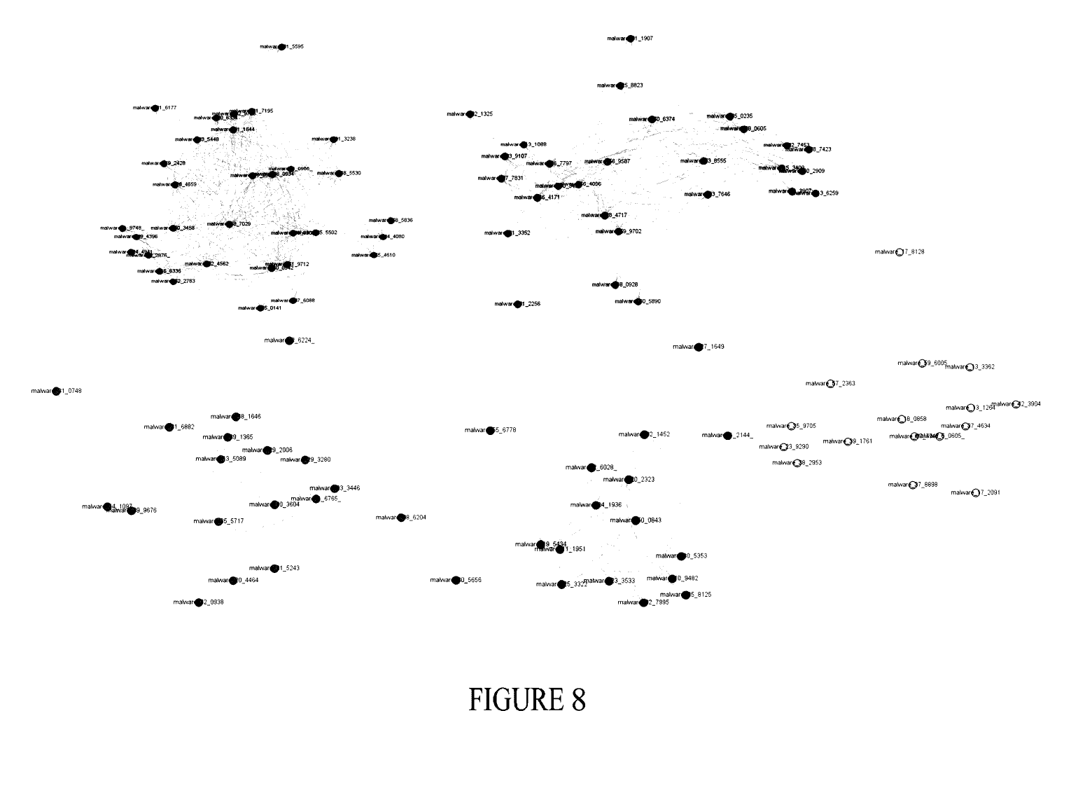

FIG. 8 shows individual clusters that were randomly selected to verify the results of FIG. 7. To verify the accuracy of the results, the content of randomly chosen clusters of malware instances were manually analyzed. To confirm verifications, antivirus (AV) scanners analyzed the malware instances. Table 1 summarizes the analysis results of some of the AV scanners. Surprisingly, some of the malware variant instances of the sample clusters, although released years ago, went undetected by the AV scanners. The overall percentage of accuracy of this run was sixty-one percent.

TABLE 1
Detection Results

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | Luder | 32 | 12 | 20/32 | 62.5% |
| Cluster 2 | Patched.GN2 | 24 | 15 | 9/24 | 37% |
| Cluster 3 | Trojan-gen | 14 | 6 | 8/14 | 57% |
| Cluster 4 | Luder | 10 | 2 | 8/10 | 80% |
| Cluster 5 | Luder | 10 | 3 | 7/10 | 70% |

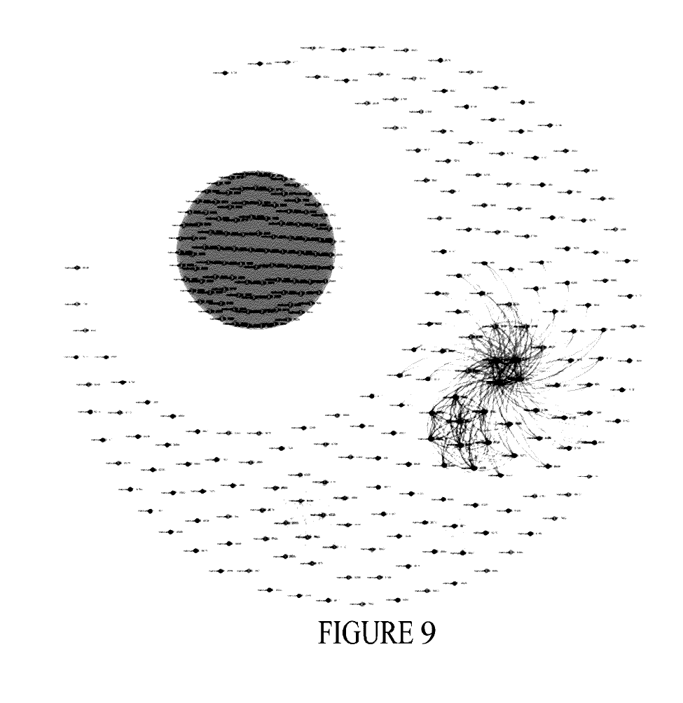

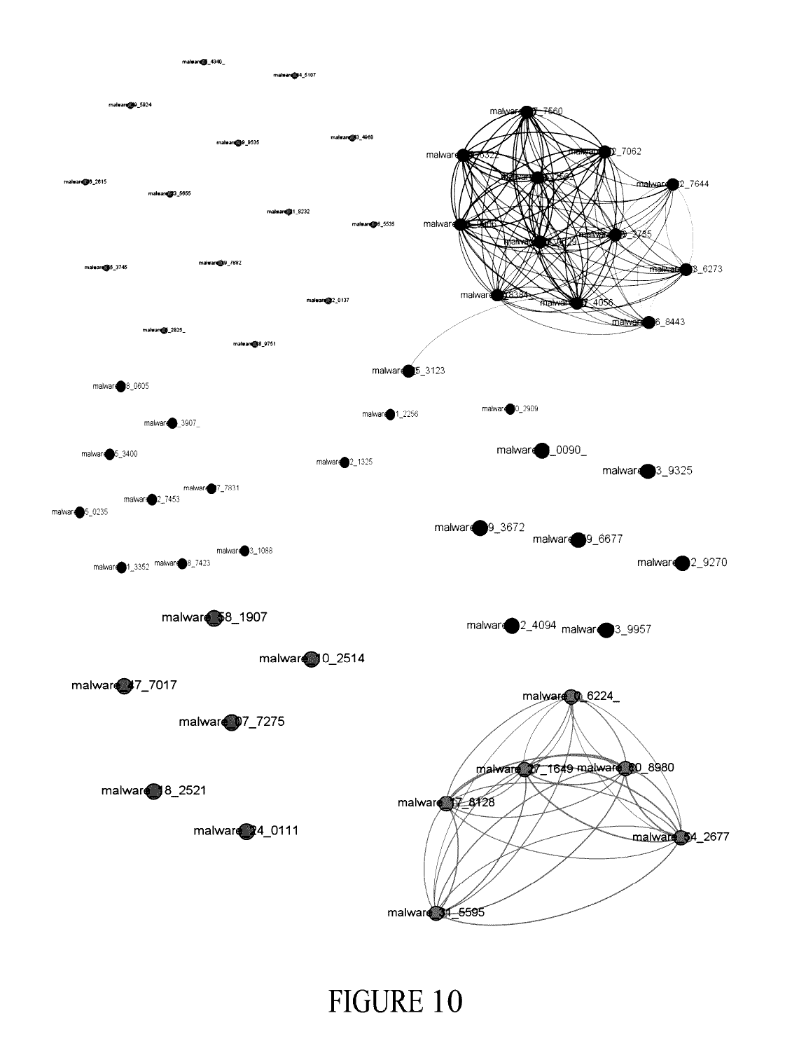

FIG. 9 shows the clustering with threshold of the smallest string divided by five with seventy percent shared functions. As in the previous exemplary use, the nodes represent the malware instances of the sample and the edges represent a percentage of seventy percent or more of shared local function. The graph of this example consisted of 303 malware instances and 12059 edges. After calculating the modularity, the result of partitioning the graph's nodes consisted of 79 clusters. FIG. 10 shows sample clusters of the results generated out of this run and Table 2 shows the accuracy of the run to be about seventy percent.

TABLE 2
Detection Results

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | BackDoor/Trojan | 19 | 9 | 10/19 | 52.6% |
| Cluster 2 | Aliser | 14 | 2 | 12/14 | 85% |
| Cluster 3 | Trojan -Generic | 13 | 3 | 10/13 | 76% |
| Cluster 4 | Trojan_Patched | 9 | 4 | 5/9 | 55% |
| Cluster 5 | Luder | 7 | 1 | 6/7 | 86% |

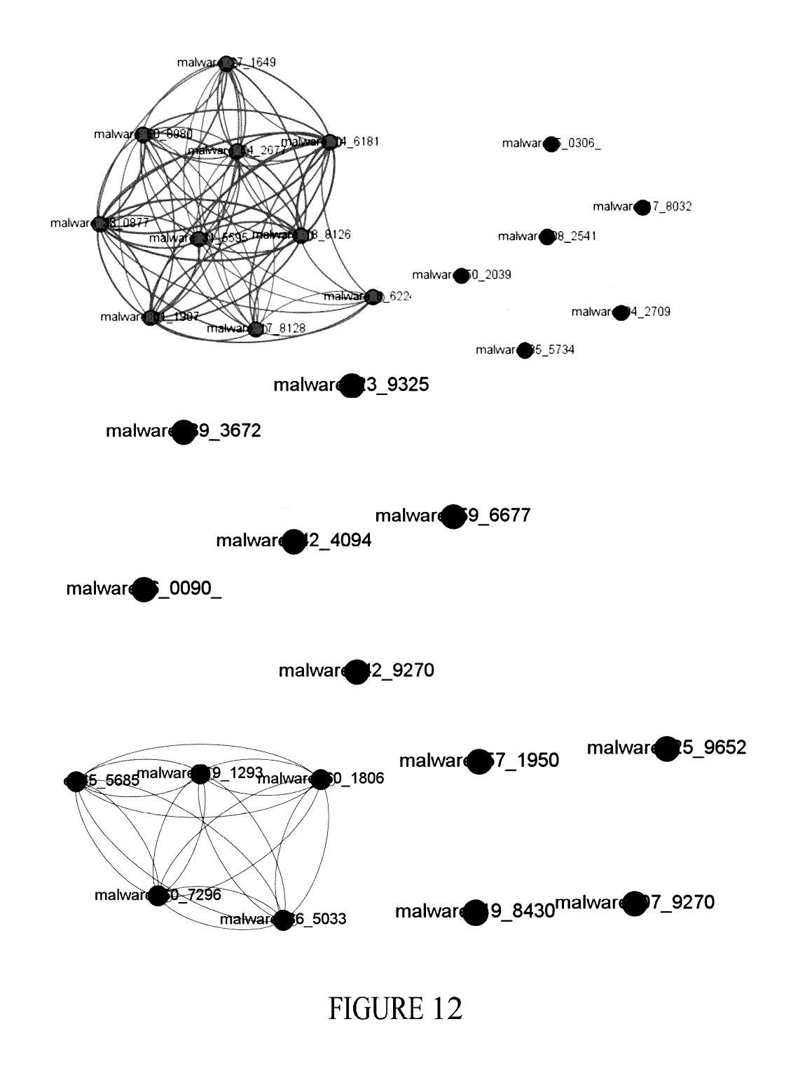

To gain a better understanding of the effect of the percentage of shared functions metric on the results, the systems (and processes) were run with a threshold value of smallest regex string divided by five for a third time, but adding edges to the graph of clusters when the number of the shared local functions between the malware instances in a cluster is ninety five percent or more. The generated graph consisted of 303 node, 11735 edges, and 122 clusters. FIG. 12 presents the full graph generated during the third run. Table 3 shows the accuracy of the run to be eighty five percent.

TABLE 3
Detection Results

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | Aliser | 14 | 2 | 12/14 | 85.7% |
| Cluster 2 | Trojan.Win32.Agent | 12 | 3 | 9/12 | 75% |
| Cluster 3 | Downloader.Adload | 10 | 0 | 10/10 | 100% |
| Cluster 4 | Win32/Parite | 6 | 1 | 5/6 | 83% |
| Cluster 5 | Trojan/Win32.Hupigon | 6 | 1 | 5/6 | 83% |

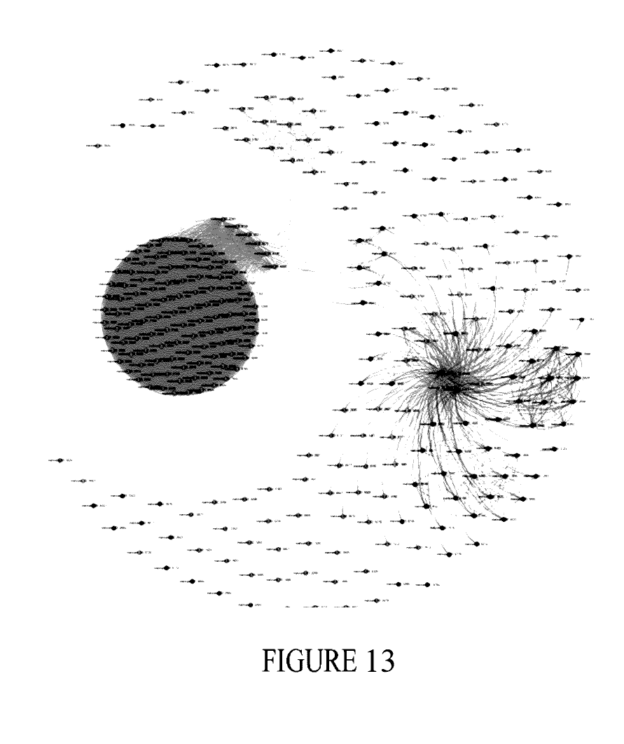

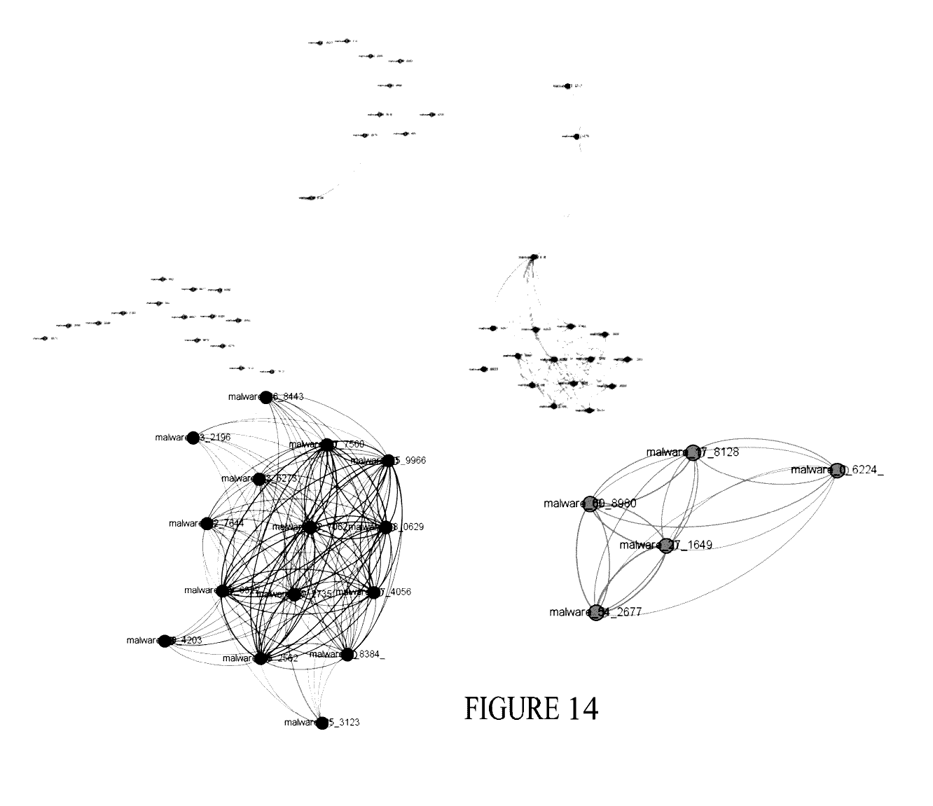

To reduce the number of unrelated malware instances clustered together, the systems (and processes) tightened up the threshold value applied by the QTC algorithm. In these use cases, the calculated threshold value was determined by dividing the length of the smallest regex string of each group by twenty rather than five, thereby requiring a higher level of similarity between the malware instances in a cluster. Like the prior use cases the systems (and processes) added edges to the clusters graph if a pair of malware instances share fifty percent, seventy percent and ninety-five percent of the total local function of each malware instance. FIG. 13 presents the full graph of clusters generated by Gephi using a threshold value of the smallest regex string divided by twenty, with edges added between pairs of malware instances when fifty percent or more local functions were shared. FIG. 14 shows sample clusters that were selected randomly to verify the results. Table 4 shows accuracy of the run to be eighty four percent.

TABLE 4

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | Trojan-Gen | 18 | 6 | 12/18 | 66% |
| Cluster 2 | Win32:Trojan-gen | 15 | 4 | 11/15 | 73% |
| Cluster 3 | Win32/Parite | 6 | 1 | 5/6 | 83% |
| Cluster 4 | Downloader.Adload | 5 | 0 | 5/5 | 100% |
| Cluster 5 | Sality | 4 | 0 | 4/4 | 100% |

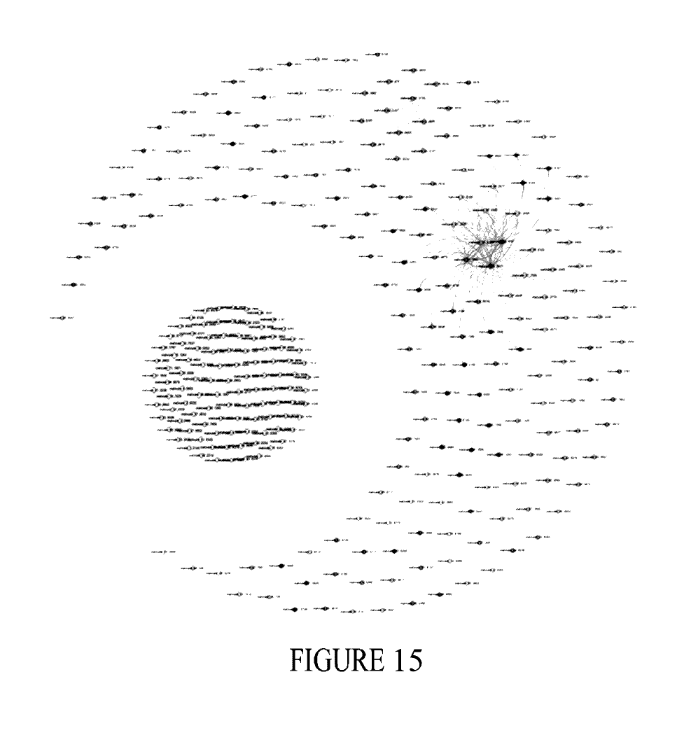

FIG. 15 shows the clustering with threshold of the smallest string divided by twenty with seventy percent shared functions. As in the previous exemplary use, the nodes represent the malware instances of the sample and the edges represent a percentage of seventy percent or more of shared local function. The graph of this example consisted of 303 malware instances and 1205 edges. After calculating the modularity, the result of partitioning the graph's nodes consisted of 97 clusters. FIG. 10 shows sample clusters of the results generated out of this run and Table 5 shows the accuracy of the run to be about ninety percent.

TABLE 5

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | Aliser | 14 | 2 | 12/14 | 85% |
| Cluster 2 | Trojan.Win32.Agent | 13 | 1 | 12/13 | 92% |
| Cluster 3 | Dowloader.Adload | 13 | 3 | 10/13 | 76% |
| Cluster 4 | Partie | 6 | 0 | 6/6 | 100% |
| Cluster 5 | Downloader.Adload | 6 | 0 | 6/6 | 100% |

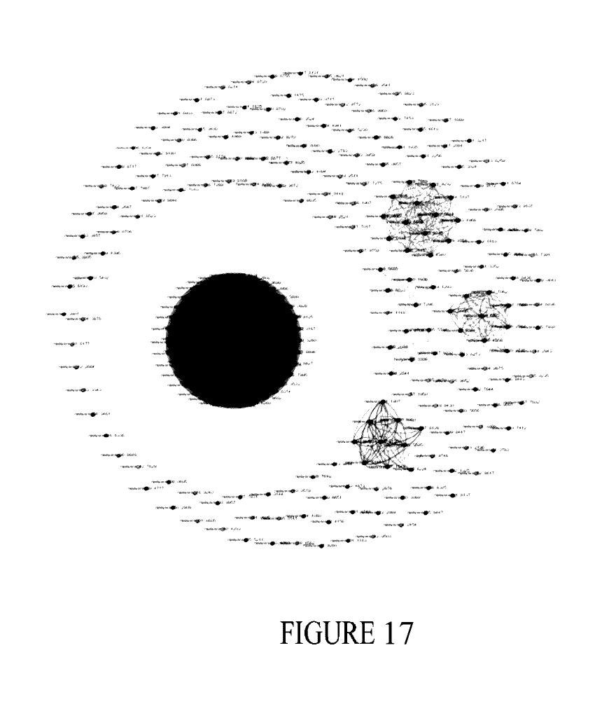

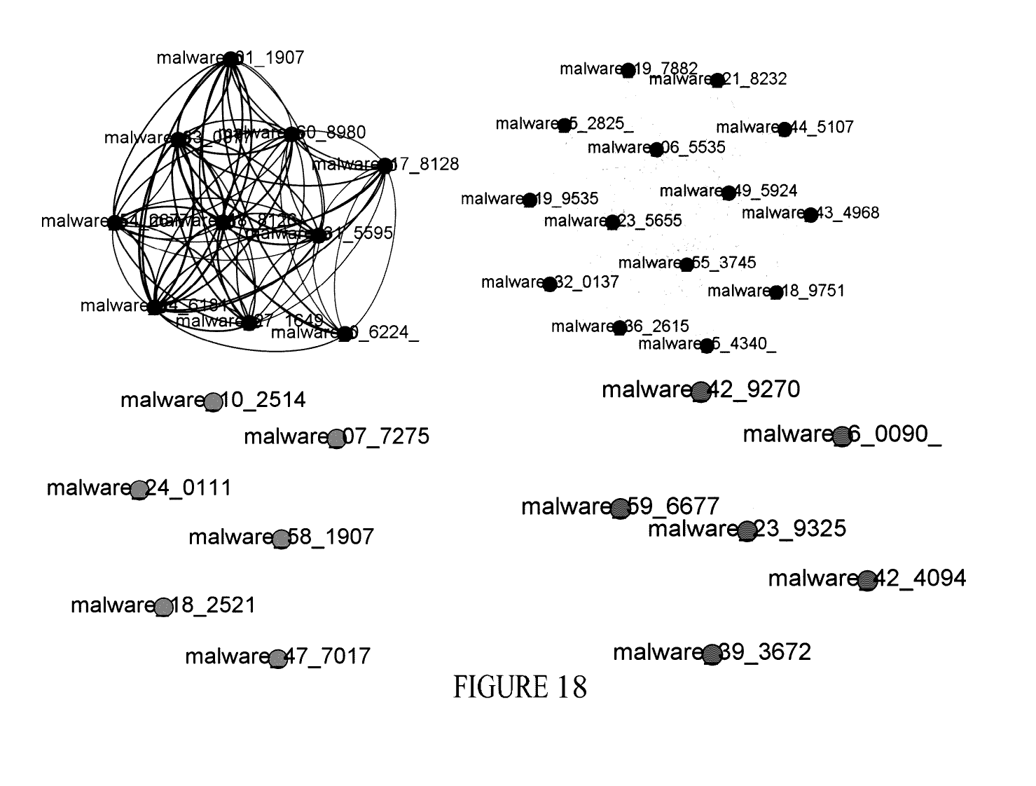

FIG. 17 shows the clustering with threshold of the smallest string divided by twenty and edges added when a pair of malware instances shared ninety five percent of their total local functions. The graph of this example consisted of 303 malware instances and 11743 edges. After calculating the modularity, the result of partitioning the graph's nodes consisted of 122 clusters. FIG. 18 shows sample clusters of the results generated out of this run and Table 6 shows the accuracy of the run to be about ninety two percent.

TABLE 6
Detection Results

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | Aliser | 14 | 2 | 12/14 | 85% |
| Cluster 2 | Win32:Trojan-gen | 12 | 1 | 11/12 | 91.6% |
| Cluster 3 | Downloader.Adload | 10 | 0 | 10/10 | 100% |
| Cluster 4 | Win32/Parite | 6 | 1 | 5/6 | 83% |
| Cluster 5 | TR/Patched.Gen2 | 6 | 0 | 6/6 | 100% |

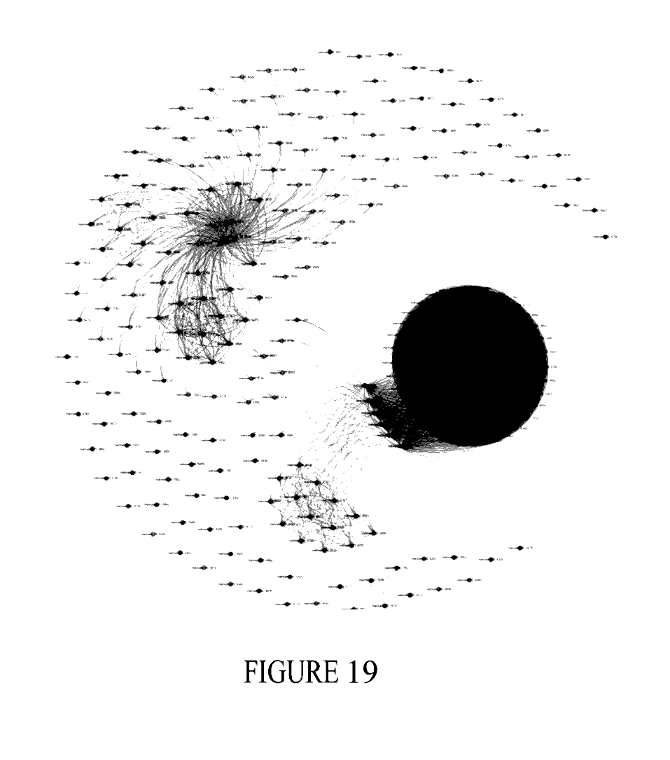

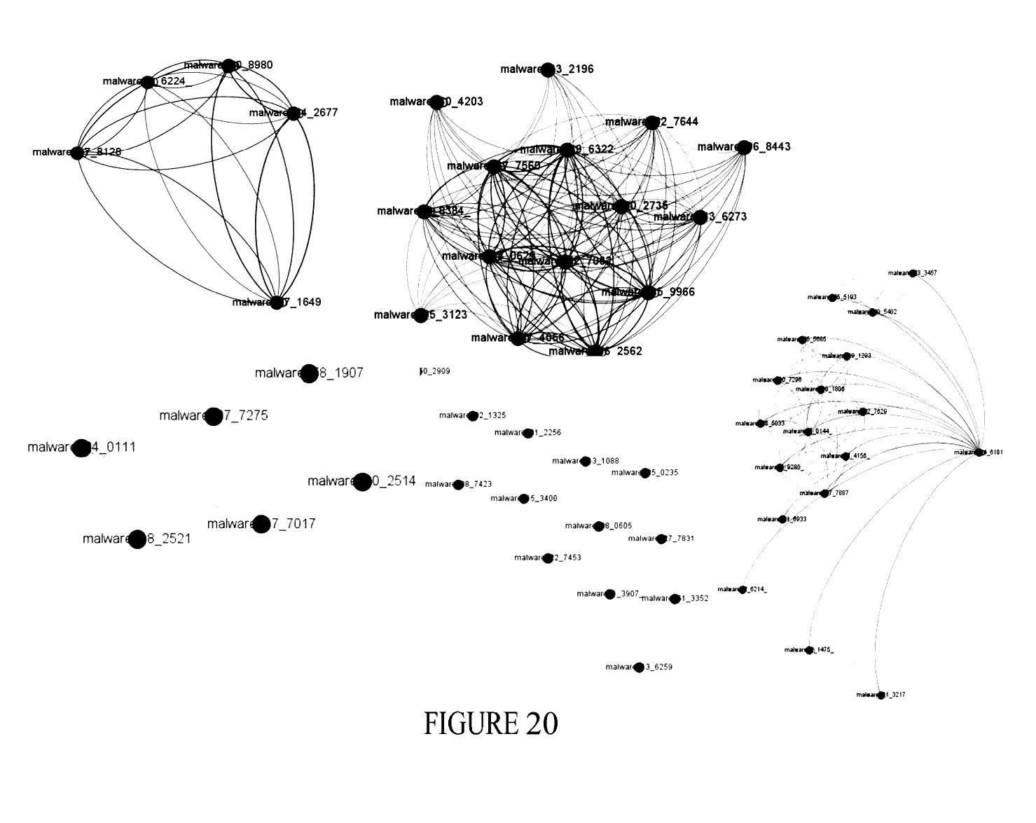

FIG. 19 shows the clustering with threshold of the smallest string divided by fifty and to edges added when a pair of malware instances shared fifty percent of their total local functions. The graph of this example consisted of 303 malware instances and 13273 edges. After calculating the modularity, the result of partitioning the graph's nodes consisted of 51 clusters. FIG. 20 shows sample clusters of the results generated out of this run and Table 7 shows the accuracy of the run to be about ninety two percent.

TABLE 7
Detection Results

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | Win32:Trojan-gen | 15 | 1 | 14/15 | 93% |
| Cluster 2 | Win32/Virut | 13 | 0 | 13/13 | 100% |
| Cluster 3 | Win32/Parite | 6 | 1 | 5/6 | 83% |
| Cluster 4 | Win32:Trojan-gen | 6 | 1 | 5/6 | 83% |
| Cluster 5 | Downloader.Adload | 5 | 0 | 5/5 | 100% |

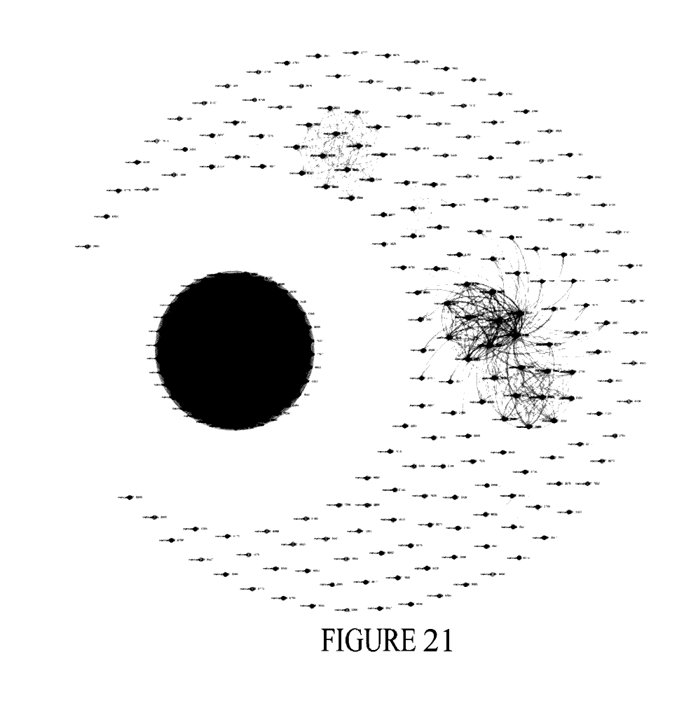

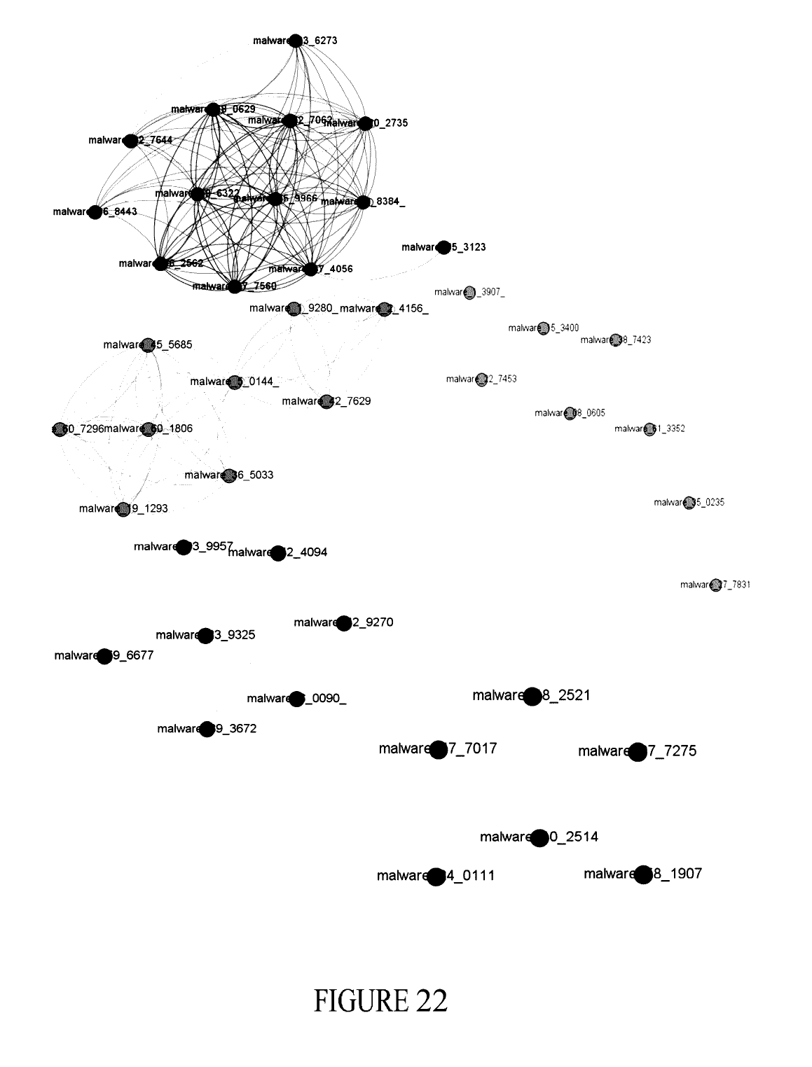

FIG. 21 shows the clustering with threshold of the smallest string divided by fifty and edges added when a pair of malware instances shared seventy percent of their total local functions. The graph of this example consisted of 303 malware instances and 12001 edges. After calculating the modularity, the result of partitioning the graph's nodes consisted of 88 clusters. FIG. 22 shows sample clusters of the results generated out of this run and Table 8 shows the accuracy of the run to be about ninety three percent.

TABLE 8
Detection Results

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | Trojan/gen2 | 14 | 3 | 11/14 | 78% |
| Cluster 2 | Aliser | 14 | 1 | 13/14 | 93% |
| Cluster 3 | Win-Trojan | 13 | 1 | 12/13 | 92% |
| Cluster 4 | Win-Trojan | 9 | 0 | 9/9 | 100% |
| Cluster 5 | TR/Patched.Gen2 | 7 | 0 | 7/7 | 100% |

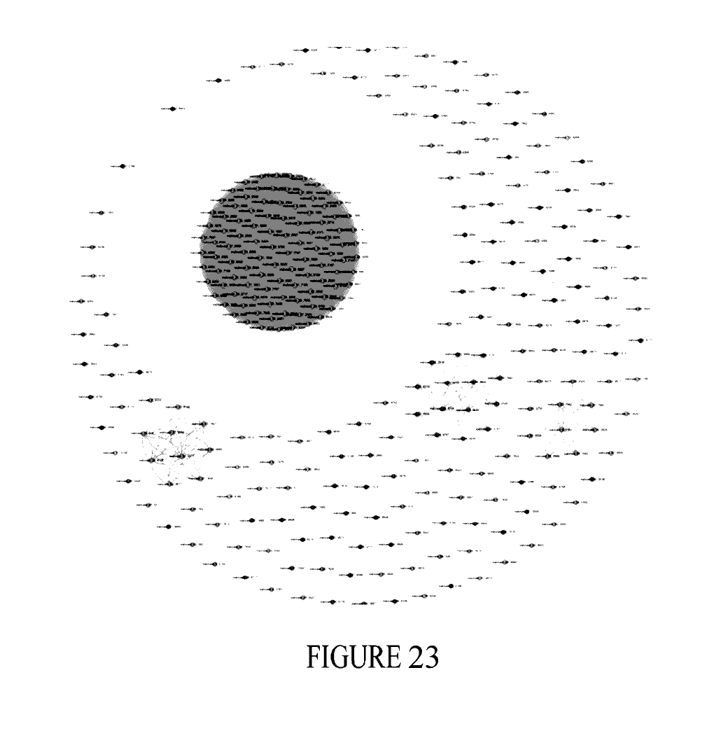

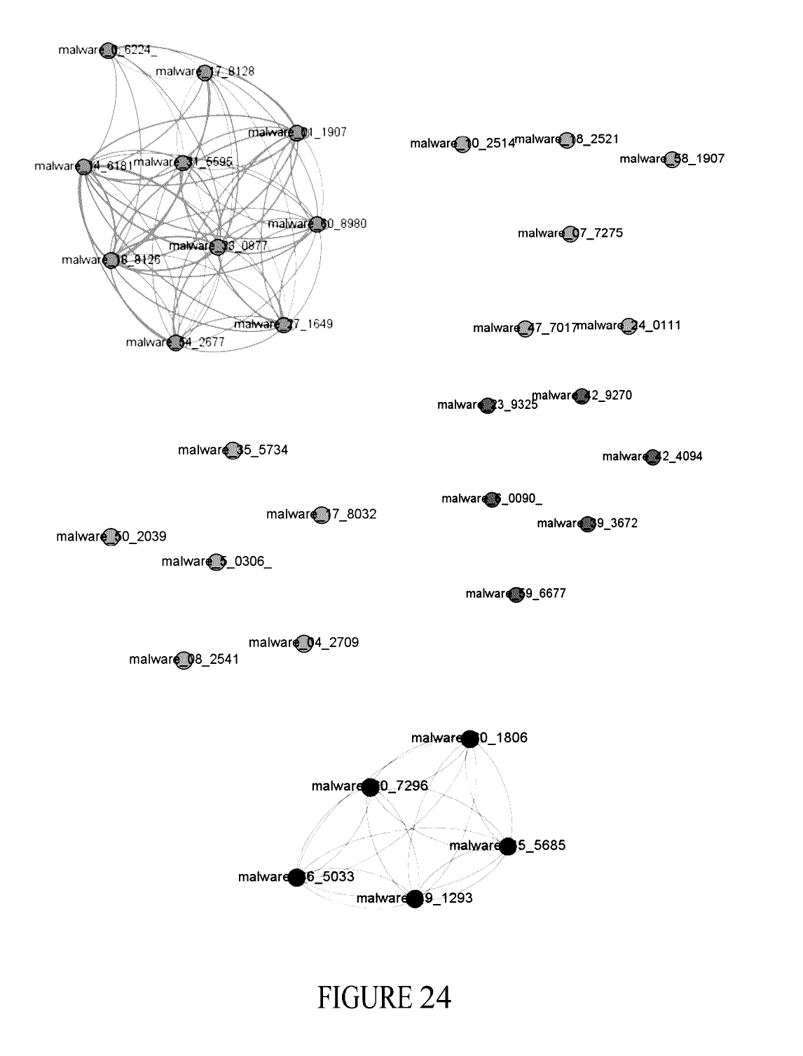

FIG. 23 shows the clustering with threshold of the smallest string divided by fifty and to edges added when a pair of malware instances shared ninety five percent of their total local functions. The graph of this example consisted of 303 malware instances and 12001 edges. After calculating the modularity, the result of partitioning the graph's nodes consisted of 88 clusters. FIG. 24 shows sample clusters of the results generated out of this run and Table 9 shows the accuracy of the run to be about ninety four percent.

TABLE 9
Detection Results

| | General | Number of | Number of | | |
|---|---|---|---|---|---|
| Cluster | Malware | malware in | unrelated | Accuracy | Accuracy |
| ID | Family | the cluster | malware | ratio | percentage |
| Cluster 1 | Aliser | 14 | 1 | 13/14 | 93% |
| Cluster 2 | Trojan/Generic | 12 | 1 | 11/12 | 92% |
| Cluster 3 | Dowloader.Adload | 10 | 0 | 10/10 | 100% |
| Cluster 4 | Partie | 6 | 1 | 5/6 | 83% |
| Cluster 5 | Eluder | 6 | 0 | 6/6 | 100% |

The use cases have shown the performance of the systems (and processes) using different metrics. In the first use case, where a threshold value of smallest regex string divided by five was used, the results reflected a percentage of accuracy that ranged between 61% -85%. In the second use case, the threshold value was tightened up by using the value of the smallest regex string length divided by twenty for the threshold value. The results established accuracy between 84%-92%. In the third use case, the systems (and processes) established the length of the smallest regex string length, and dividing it by fifty. The results showed accuracy between 92%-94%. Table 10 summarizes the results.

TABLE 10
Results

Run

| | Run One | Run Two | Run Three |
|---|---|---|---|
| | 50% Shared | 70% Shared | 95% Shared |
| Experiment | Functions | Functions | Functions |
| Experiment One | 61% | 70% | 85% |
| QT = Smallest/5 | | | |
| Experiment Two | 84% | 90% | 92% |
| QT = Smallest/20 | | | |
| Experiment Three | 92% | 93% | 94% |
| QT = Smallest/50 | | | |

The results established that tightening up the threshold value increases the accuracy of the output of the systems (and processes). The threshold value determines the acceptable variance between the malware instances regex strings. The results further established that the systems (and processes) effectively detect variant of malware families based on constructed SCFs. The SCFs were generated by first analyzing targeted software through an automatic analysis static tool like the FX tool to render the SCF regex strings of their individual local functions. The SCF regex strings were processed by the systems (and processes) through its automated clustering application. After generating initial clusters, the local functions of the malware instances were mapped to malware instance, and the number of shared functions that had similar SCFs were processed between malware instances and a sample set. Based on the percentage of shared function, the systems (and processes) clustered the malware instances into probable malware families.

The results of the systems (and processes) can be used to build a catalog of malware families based on candidates of malware variant that represents each family. When an unknown program is detected, a representative malware family from a catalog of malware families can be processed by the systems (and processes) to check the SCF of the targeted program against the SCF of the candidate malware variants. Unknown malware can be either classified as a variant of a malware family that is present in the catalog, or added as a new unclassified program.

The systems (and processes) and logic described above is implemented in many different ways in many different combinations of hardware, software or both hardware and software. For example, all or parts of the system may diagnose software or circuitry in one or more controllers, one or more microprocessors (CPUs), one or more signal processors (SPU), one or more servers connected to a network or cloud service (i.e., a server is defined as one or more computers or devices connected to a distributed network via one or more network connections, with each computer or device having one or more applications that generate structured flow control such as a static module; one or more applications that transform the structured flow control into an artifact in which distance may be measured, a clustering application, a server database application(s), and server network application(s)). All or parts of the system may diagnose software through one or more graphics processors (GPUs), one or more application specific integrated circuit (ASIC), one or more programmable media or any and all combinations of such hardware. All or part of the logic, specialized processes, and systems described may be implemented as instructions for execution by multi-core processors (e.g., CPUs, SPUs, and/or GPUs), controller, or other processing device including exascale computers and computer clusters, and may be displayed through a display driver in communication with a remote or local display, or stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The systems (and processes) evaluate software and data structures through processors (e.g., CPUs, SPUs, GPUs, etc.), memory, interconnect shared and/or distributed among multiple system components, such as among multiple processors and memories, including multiple distributed processing systems. Parameters, databases, software and data structures used to evaluate and analyze these systems or logic may be separately stored and managed, may be incorporated into a single memory or database, may be logically and/or physically organized in many different ways, and may implemented in many ways, including data structures such as linked lists, programming libraries, or implicit storage mechanisms. Programs may be parts (e.g., subroutines) of a single program, separate programs, application program or programs distributed across several memories and processor cores and/or processing nodes, or implemented in many different ways, such as in a library, such as a shared library. The library may store behavior abstractions that performs analyze the behavior functionality described herein. While various embodiments have been described, it will be apparent to those of ordinary skill in the art that many more embodiments and implementations are possible.

The term “coupled” disclosed in this description may encompass both direct and indirect coupling. Thus, first and second parts are said to be coupled together when they directly contact one another, as well as when the first part couples to an intermediate part which couples either directly or via one or more additional intermediate parts to the second part. The term “substantially” or “about” may encompass a range that is largely, but not necessarily wholly, that which is specified. It encompasses all but a significant amount, such as a variance within five or ten percent. When devices are responsive to commands events, and/or requests, the actions and/or steps of the devices, such as the operations that devices are performing, necessarily occur as a direct or indirect result of the preceding commands, events, actions, and/or requests. In other words, the operations occur as a result of the preceding operations. A device that is responsive to another requires more than an action (i.e., the device's response to) merely follow another action.

It encompasses all but a significant amount, such as a variance within five or ten percent. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method of detecting malware on a computerized system comprising:
accessing a digital software from a file;
building a structured flow control that maps the software's execution paths;
evaluating the structured flow control using a plurality of distance measures to determine if a portion of the software is malicious.

2. The method of claim 1 where the building of the structured flow control comprises disassembling the executable code of the digital software and scanning the disassembled executable for code instructions.

3. The method of claim 2 where the software's execution paths are free of jump paths.

4. The method of claim 1 where the structured flow control comprises a string notation that is an abstraction of a disassembly of an executable code that comprises the digital software.

5. The method of claim 4 where the abstraction comprises if-then-else instructions, loop instructions, and call instructions.

6. The method of claim 1 where the structured flow control comprises a tree structure that is an abstraction of a disassembly of an executable code that comprises the digital software.

7. The method of claim 1 further comprising automatically designating portions of the software malicious based on a distance measure between software nodes.

8. The method of claim 7 further comprising calculating a threshold value for a clustering process that segregates a plurality of malware families.

9. The method of claim 1 further comprising designating a portion of the software into a plurality of malware families based on a number of shared software functions.

10. The method of claim 1 further comprising designating a portion of the software into a plurality of malware families based on a measured similarity the structured flow control and a second structured flow control.

11. The method of claim 1 further comprising building a malware candidate cluster by determining the data points the comprise the structure flow control having the greatest similarity.

12. The method of claim 1 where the act of building a structured flow control that maps the software's execution paths are generated from an automated static analysis.

13. The method of claim 1 where the act of determining if a portion of the software is malicious comprises determining if the portion of the software comprises known malware or a variant of known malware.

14. A networked computer server device, comprising:
a network connection operable to access software from a digital file;
a software static module coupled to the network connection operable to build a structured flow control of the software that maps execution paths of the software;
a cluster module coupled to the software static module operable to evaluate the structured flow control using a plurality of distance measures to determine if a portion of the software is malicious.

15. The networked computer server device of claim 14 where the structured flow controls comprises a regex string.

16. The networked computer server device of claim 14 where the structured flow control comprises tree structure.

17. The networked computer server device of claim 14 where software static module constructs a file containing the disassembled executable code of the software.

18. The networked computer server device of claim 14 where the software static module coupled and the cluster module comprises a server cluster.

19. The networked computer server device of claim 14 where the determination if a portion of the software is malicious is based on a computed behaviour of the software.

20. A machine-readable medium with instructions stored thereon, the instructions when executed operable to cause a computerized system to:
access a digital software from a file;
build a structured flow control that maps the software's execution paths; and
evaluates the structured flow control using a plurality of distance measures to determine if a portion of the software is malicious.

21. The machine-readable medium of claim 20 where the structured flow control comprises a tree structure that is an abstraction of a disassembly of an executable code that comprises the digital software.

22. The machine-readable medium of claim 20 wherein the instructions when executed are operable to cause a computerized system to disassemble the executable code of the digital software and scan the disassembled executable for code instructions.
